(19) United States
(12) Patent Application Publication
(10) Pub. No.: US 2007/0271552 A1
(43) Pub. Date: Nov. 22, 2007

(54) System and method for packaging software

(76) Inventor: Robert A. Pulley, Irving, TX (US)

Correspondence Address: MICHAEL L. DIAZ, P.C., 555 REPUBLIC DRIVE, SUITE 200, PIANO, TX, 75074, US

(21) Appl. No.: 11/437,493

(22) Filed: May 19, 2006

(51) Int. Cl. G06F 9/44

(52) U.S. Cl. 717/120

(57) ABSTRACT

A method and system for packaging software using a graphical user interface (GUI) to simplify the creation and modification of System V and Red Hat Package Manager (RPM) software packages. The software packaging system provides a fully interactive graphical interface portable across many platforms including Linux, Unix System V, Solaris, and AIX. RPM is a popular and powerful packaging system that installs and removes system software, enforces dependencies, and is freely available on a number of different platforms. The software packaging system of the present invention simplifies and speeds the creation of deployable RPM software packages, a complex and time consuming task if created using the RPM command line method. The GUI provides for the collection of information required for RPM software package creation, modification, and feature manipulation reducing the skill level and time that needed to perform these functions using the RPM command line.

### FIELD OF THE INVENTION

This invention relates to software packaging. Specifically, the present invention relates to a system and method for packaging software using a graphical user interface (GUI) to assist in the creation of various software packages.

### DESCRIPTION OF THE RELATED ART

The present invention is a method and system for packaging Unix or Linux software in a computing system. The deployment of software is often complicated, time-consuming, and costly to a company. A software package is a collection of related files which range from the typical collection of binaries and manual pages to full-blown, expansive software development kits (SDKs) that include, but not limited to tools, libraries, documentation, and source code. Before the advent of formal package formats and package managers, computer software operators typically archived and distributed software in one or more tarballs. A tarball is a tar file or a compressed variant of a tar file. The tarball is utilized to install software by extracting tarballs on their systems. While useful, the simplicity of a tarball offers some serious drawbacks. A tarball is merely an inert collection of files, and once extracted, there's no way to match an installed file to its tarball (or to other related files) or reconstitute the tarball. In addition, a tarball is unable to describe its prerequisites or its incompatibilities.

Formal package managers address some of these disadvantages. True software packages include metadata as well as archived files (e.g., system V (PKG) and Red Hat Package Manager (RPM)). Package managers utilize this metadata to implement intelligence into file handling. Metadata expresses version numbers, prerequisites, package inventory, and can also include install and uninstall scripts that execute at package installation and removal, respectively. These package managers provide coordination by tracking all of the pieces in a package. However, creating and maintaining a software package requires the user to be knowledgeable of the software package manager commands, syntax and procedures.

For a package manager utilized in various platforms versions and architectures (e.g., Linux, System V, Solaris, and AIX), typically a highly skilled operator in each of these platforms is required for the installation of software packages. A system and method are needed for implementing a graphical user interface (GUI) that issues the package manager commands for the user and obviates the need for the user to be familiar with the underlying package manager commands and creation procedures enabling rapid generation of deployable software packages by the average software developer or build master.

There are various installation tools available for the installation of Windows software programs in the marketplace (e.g., Macrovision's InstallShield and Altiris' Wise). However, none of these package installation tools have addressed packages utilized on Linux or Unix operating platforms. None of these existing Windows-based systems provide access to a raw .rpm file. Rather, the existing systems execute the RPM installation commands for the user. In addition, the GUIs of these existing systems are designed to be an installer/uninstaller GUI on the target system with the ease of end users in mind. There is no mechanism for writing customized scripts within their tool. In addition, adapting Windows installer GUI to Linux or Unix servers is unnecessary because RPM already does the installing and uninstalling. Additionally, the Windows technology and environment is not appealing to experienced Linux or Unix users.

Existing RPM packages are complex and error prone when numerous files are involved. The user must manually create the package environment and create a directory structure of the package. In addition, the user must create the package specifications and utilize the packaging language. The user must also manually create request scripts for package files, manually move or copy the files into the package environment and manually maintain file attributes. A few techniques relating to the creation of RPM packages have been described and implemented in the existing art. These existing techniques suffer from several disadvantages. The RPM packages only address the inclusion of RPM files into an installer GUI and do not provide access to the raw rpm file needed for a user to control RPM install/uninstall commands and flags. The RPM packages rely on the target system to support Java and a graphical environment. Thus, deploying the installer to mass servers would be virtually impossible because of the rarity in having a graphical environment installed on all production backend database, web, or application servers. The interface is also cumbersome and time consuming to successfully create an encapsulated RPM package in an installer file. A system and method are needed which creates a package file quickly and intuitively while supporting RPM features prevalent in RPM packages, such as pre-install, install, and post-install scripting, digital signing, or RPM spec file editing.

It would be advantageous to have a system and method for managing, creating and maintaining RPM and System V software packages through a graphical user interface (GUI) instead of using the command line method. It would also be advantageous for the GUI to provide custom scripts that enable a user to subsequently leverage native RPM to install, query, and uninstall packages in a standard Linux or Unix server environment. It is an object of the present invention to provide such a method and system.

### SUMMARY OF THE INVENTION

In one aspect, the present invention is a software packaging system. The software packaging system includes a computing system operating a Unix or Linux operating platform, a software package executable by the operating platform, and a graphical user interface (GUI) operable within the computing system and operating platform. The GUI has a user interface element actuable by a user. The user interface element provides management of packaging of the software package in the computing system.

In another aspect, the present invention is a method of packaging a software package within a computing system operating a Unix or Linux operating platform. The method provides a graphical user interface (GUI) operable within the computing system and operating platform. The user provides executable instructions to the GUI. The GUI has a user interface element providing management of packaging of the software package in the computing system.

In still another aspect, the present invention is a software packaging system. The software packaging system includes a computing system operating a Unix or Linux operating platform and a software package executable by the operating platform. The operating platform operates a native package manager for managing installation of the software package. The system also includes a graphical user interface (GUI) operable within the computing system and operating platform. The GUI has a user interface element actuable by a user. The user interface element provides management of packaging of the software package in the computing system. The user interface element manages a plurality of software package projects, wherein each project is associated with a software package. In addition, the user interface element provides a listing of system files and attributes available for inclusion into the software package and a capability for entering specific required or optional package information to the software package. The user interface element provides the capability for modifying file or directory attributes of the software package, modifying the native package manager flags, managing package dependencies, and managing script executable at installation, uninstallation or verification time of the software package within the computing system.

### BRIEF DESCRIPTION OF THE DRAWINGS

FIG. 1 is a simplified block diagram of a packaging system in the preferred embodiment of the present invention;

FIG. 2 illustrates a screen shot of the GUI allowing the packager to create new projects containing software packages in the preferred embodiment of the present invention;

FIG. 3 illustrates a screen shot of the GUI for generating and managing required and optional RPM parameters and specific package information;

FIG. 4 is a screen shot of the GUI that allows users to open, save and close existing projects containing software packages;

FIG. 5 is a screen shot of the GUI that enables the packager to drag and drop selected files to be packaged from a source environment to a target packaging environment graphically creating a packaging tree;

FIG. 6 is a screen shot of the GUI that enables a user to display files to be included in the software package;

FIG. 7 illustrates a screen shot of the GUI that enables a user to modify directory properties;

FIG. 8 illustrates the screen shot of the GUI that enables the packager to modify OS security parameters;

FIG. 9 illustrates a screen shot of the GUI that enables the packager to modify RPM flags;

FIG. 10 is a screen shot of the GUI that enables a packager to manage package dependencies;

FIG. 11 is a screen shot of the GUI that enables a user to manage package dependencies with an “advanced settings” tab selected;

FIG. 12 is a screen shot of the GUI for starting the RPM package building process;

FIG. 13 illustrates the GUI displaying the package information selected;

FIG. 14 is a screen shot of the GUI displaying the package building progress and activity of the package;

FIG. 15 illustrates a screen shot of the GUI displaying the package build completion status; and

FIG. 16 is a simplified block diagram of a network for use by packagers for building a package remotely.

### DESCRIPTION OF THE INVENTION

The present invention is a method and system for packaging Unix or Linux software in a computing system. The present invention may be classified as a Software Configuration Management (SCM) tool. SCM tools are used by application development organizations to provide software revision control and versioning capabilities. More sophisticated functions, such as process management, change request tracking, requirements management, and distributed team development support may be included.

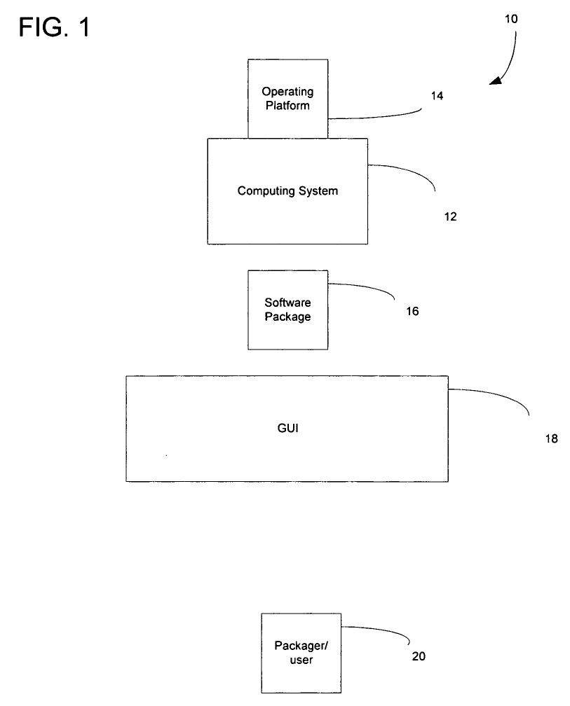

FIG. 1 is a simplified block diagram of a packaging system 10 in the preferred embodiment of the present invention. The packaging system includes a computing system 12 operating a Linux or Unix operating platform 14. A software package 16 is desired to be implemented upon the computing system 12. The present invention includes a GUI 18 to allow a packager or user 20 to implement the software package 16 upon the computing system 12. The computing system 12 may be any computer or network of computers.

The present invention utilizes system level packaging to create software packages through the GUI 18. The GUI 18 and various features of the present invention will be explained below. It should be apparent to one skilled in the art that the present invention includes additional software packaging features and tasks not described in detail herein may be provided in the packaging system. The present invention provides further integration with software configuration management systems, such as code management, or deployment software and achieves additional value to software packagers through improved software deployment accuracy, deployment speed, and elimination of manual, repetitive, software packaging tasks. The present invention preferably may be run on any UNIX or Linux based operating system which may include various versions and architectures such as Linux, Solaris, AIX, System V and HP-UX.

The GUI 18 provides the user 20 with an uncomplicated approach towards packaging in both RPM and System V formats. The main screen of the GUI 18 is a single point of navigation throughout the package creation process. There is a menu 40 that is available on all screens that allows the packager 20 to execute an open, save, close, exit, and build of package projects. There is a navigation icon bar 50 that also provides the packager 20 with the ability to navigate through various different screens, which will be explained below. In the preferred embodiment of the present invention, these interfaces may include “new project wizard, open, close, save, information, package files, dependencies, scripts, summary, build, and stop” screens.

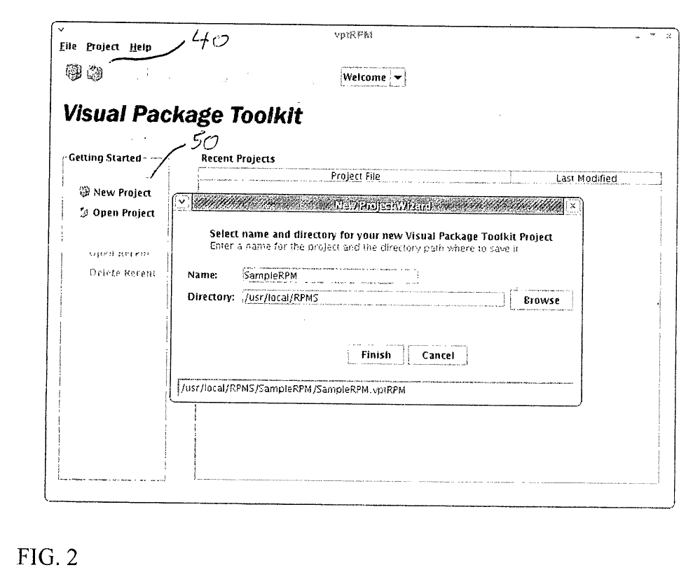

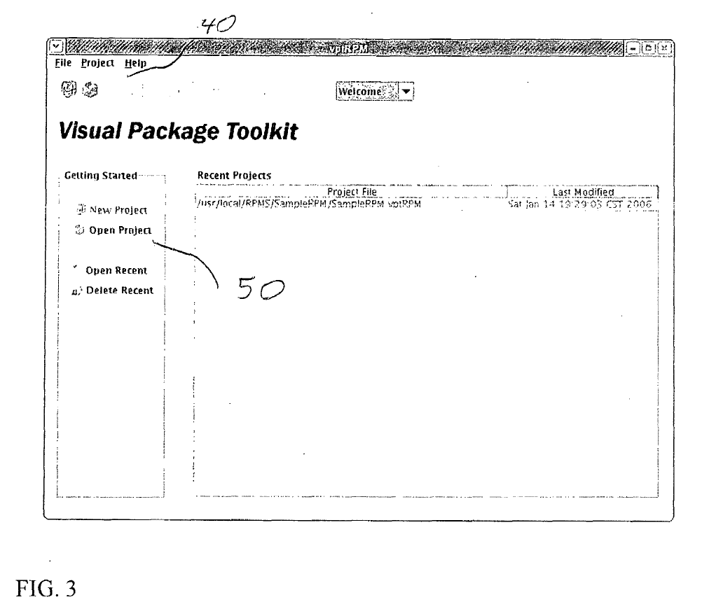

FIG. 2 illustrates a screen shot of the GUI 18 allowing the packager 20 to create a new project containing a software package 16 in the preferred embodiment of the present invention. The navigation icon bar 50 includes an icon (new project wizard) that when selected, creates a new package project. When the “new project wizard” icon is clicked using a pointing device, a new window (as shown in FIG. 1) appears. The packager 20 may then enter the name of the project and the directory in which the new project is to be built. The new project wizard feature within the GUI 18 allows the packager 20 to browse the computer directory structure and select the directory in which the project is to be created. The packager may also manually type the path to where the project is to be saved. A “finish” button is preferably provided once the name of the project and directory location have been inputted into the appropriate fields to close the new project wizard. If the project already exists, the packager is prompted by the GUI 18 to overwrite any existing project with a “yes” or “no” prompt. Selecting “yes” overwrites the existing project, while a “no” returns the packager back to the new project wizard. Once the name and directory of the project have been appropriately designated by the packager and the finish button is pressed, the “information” screen (see FIG. 3) is initiated automatically.

FIG. 3 illustrates a screen shot of the GUI 18 for generating and managing required and optional RPM parameters and specific package information. The information screen consists of both required and optional fields for input. For example, the following are examples of the required fields:

### Required Fields

Name:
Version:
Release:
Group:
License:
Summary:
Description:

The “Name” field is a required field which designates the name of the package. The name of the package is identified, installed or removed by the packaging software (RPM, System V) on the system. The “Version” field is a required field that is assigned the software version identifier to the package. The version is an arbitrary number that the packager selects. The “Release” field is a required field that is assigned the software release to the package. The release is an arbitrary number that the packager selects and designates the release value of a package. The “Group” field is a required field that is a drop-down menu that is specific to RPM and lists all of the possible groups that are relevant to RPM. The “License” field is a required field that is used to identify what type of license is used for the package. This is an arbitrary value that the packager 20 determines. An example of the type of license used is “GPL” which means General Public License. The “Summary” field is a required field that provides a space for the packager to type a summary description of the package. The “Description” field is a required field that provides a space for the packager 20 to type a detailed description of the package.

The following is exemplary optional fields:

### Optional Fields

Packager:
URL:
Vendor:

### The optional information is on the information screen so if data is input into the optional fields, that information may be easily queried using the packaging software on the target system.

The information screen may also include a “sign package” icon shown at the bottom of the screen shot depicted in FIG. 3 (not depicted in FIG. 3). The sign package icon provides package security enabling the packager to digitally sign the created package with a predefined signature that has been created on the packaging system. With a signed package, the packager 20 may check for both integrity and authenticity of the package. An integrity check may be conducted by validating SHA-1 hash embedded into the signature. Authenticity is ensured by checking signer's credentials against a trusted list that is pre-installed on the computing system 12 where the package 16 is to be installed.

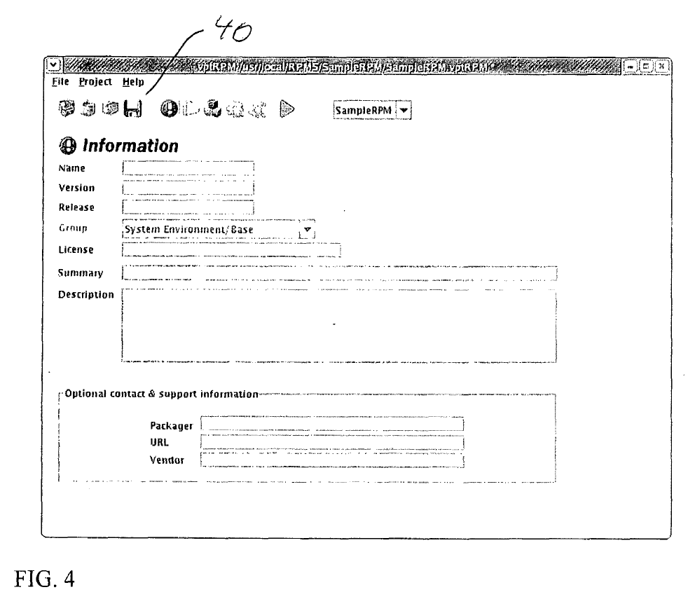

FIG. 4 is a screen shot of the GUI 18 that allows users to open, save and close existing projects containing one or more software packages. The GUI allows the packager 20 to manipulate existing projects as desired.

The GUI also may provide several radio buttons (not shown) that identifies the type of package architecture that may be used to build the package. I386, ia64, x86_{—}64, and noarch are currently options that may be added to the spec file and used in the RPM name to identify the type of architecture the package is created as. The “packager” field is used to identify the name of the packager 20. A “URL” field may be utilized to allow input of a standard internet address for web users to browse to the internet address supplied by the packager. A “vendor” field may be supplied to identify the vendor that created and/or owns the software package 16.

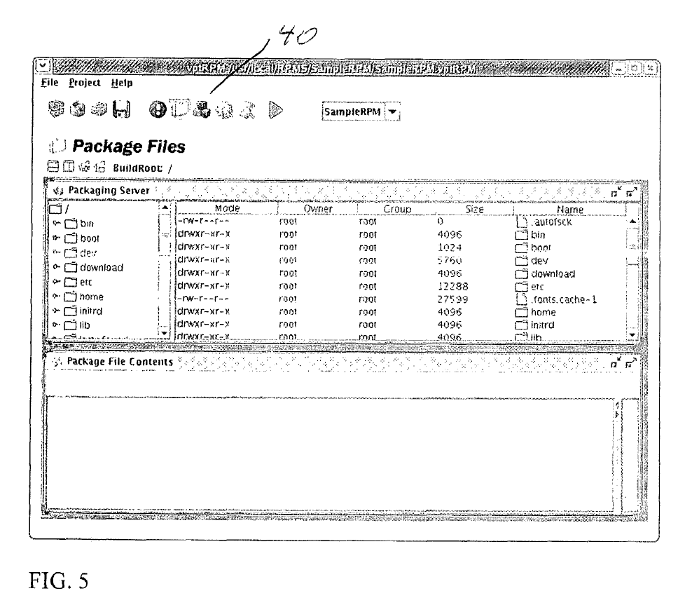

FIG. 5 is a screen shot of the GUI 18 that enables the packager 20 to drag and drop selected files to be packaged from a source environment to a target packaging environment graphically creating a packaging tree. The “package files” screen depicted in FIG. 5 shows two separate windows listing the directory structure (“package server”) and package structure (“package file contents”) on the system. These windows may optionally be tiled horizontally or vertically using the supplied icons on the screen. These windows may also be manually resized and moved to fit the packager's needs and preferences. There may also be a “build root” icon that when clicked, displays a dialog box of the build system directory structure and current build root settings. The build root is a representation of the top level directory for the package to be installed. If a packager 20 selects “I” as the build root, then the package files is installed using “I” as the top level directory for the files and directories that are installed via the package. Packagers may also create system directories and show details of files through this dialog box.

The present invention, through the GUI 18, provides a convenient graphical “drag and drop” capability that enables the packager 20 to easily drag files and directories from the server on which the GUI is running and drop into the package being created on that server, thereby saving significant time and improving accuracy over current manual packaging file selection and specification methods.

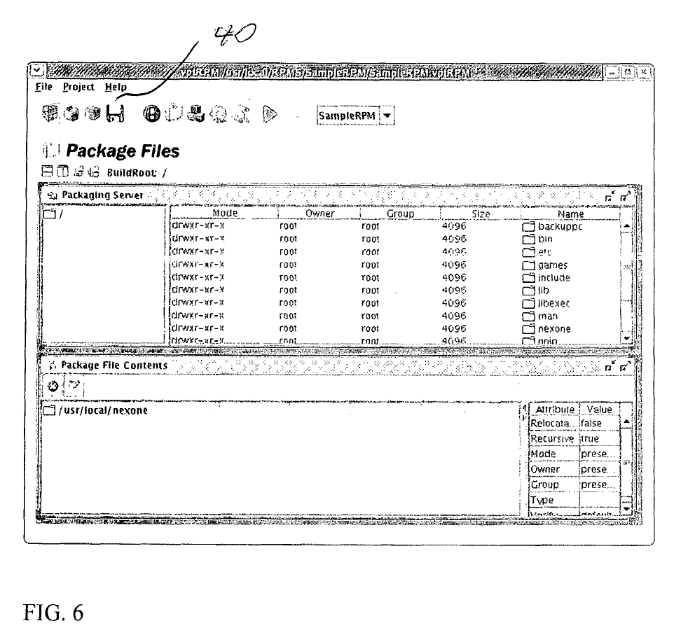

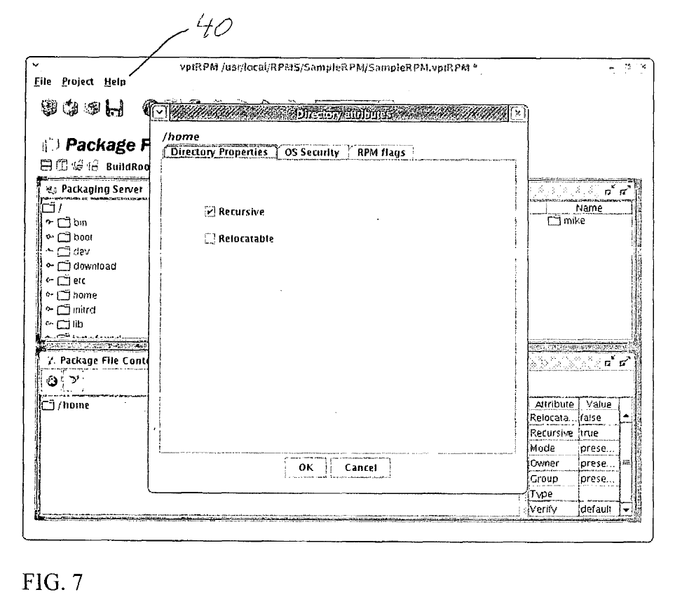

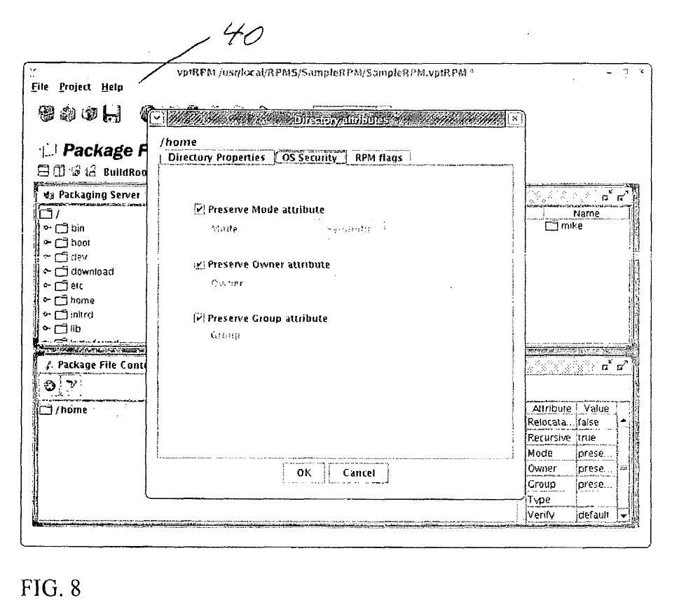

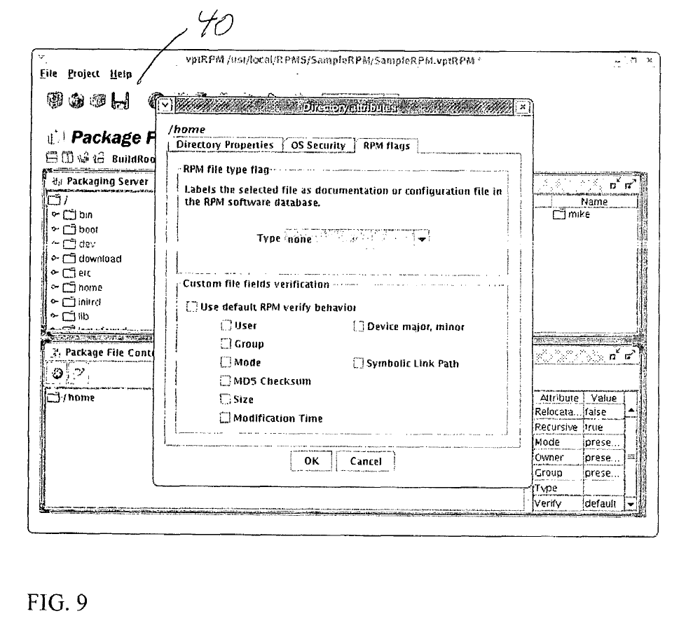

FIG. 6 is a screen shot of the GUI 18 that enables a user to display files to be included in the software package 16. FIG. 7 illustrates a screen shot of the GUI 18 that enables a user to modify directory properties. Once files are dragged to the “package files” contents window, the packager 20 has the ability to change file and directory attributes by selecting the edit icon or the provided attribute list. The packager 20 may change various attributes in the package files. The packager may be granted access based on owner, group, or other criteria. The owner attribute is the owner of the file or directory, and the group that is the group assigned to the file or directory. By selecting either a “attribute edit” icon or a “listed attribute items, a secondary window may be displayed. This window contains the modes which may be utilized. FIG. 8 illustrates the screen shot of the GUI 18 that enables the packager 20 to modify OS security parameters. The user has the option to preserve the mode, owner, and group previously assigned from the packaging server file system structure or modify the files and/or directories directly from this interface. Another feature within the file attribute interface is flags tab. FIG. 9 illustrates a screen shot of the GUI 18 that enables the packager 20 to modify RPM flags. The flags tab gives the packager the ability to modify the file flags from the default. The options within this dialog box are to set the file to either a document file or a configuration file. The other options which may be implemented are verification options that may allow the RPM subsystem to monitor the user, group, mode, MD5 Checksum, size, modification time, device major/minor, and symbolic link path. If any of the attributes listed changes, the RPM is aware of it when the user runs rpm -V against the file once the package is installed.

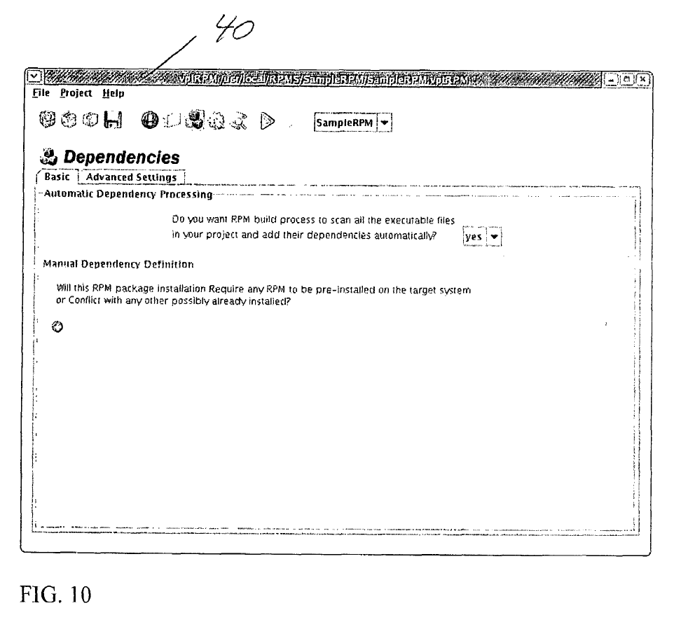

FIG. 10 is a screen shot of the GUI 18 that enables a packager 20 to manage package dependencies. FIG. 10 illustrates a “basic” tab selected and a “dependencies” screen which provides settings, packages, libraries, or anything that the package “depends” on to be installed. The first tab preferably includes the “basic” dependency settings. Within this tab the packager 20 may select whether the package should process automatic dependencies by selecting “yes” or “no” from a dropdown menu inside an “automatic dependency processing” section of this screen. If “yes” is selected the package attempts to identify what types of dependencies are required and check whether the dependency is on the system where the package is being installed. The dependencies screen may also provide another section providing a “manual dependency” definition. This section provides the packager 20 the ability to input specific dependency packages. In the preferred embodiment of the present invention, there are three icons provided that allow for adding, editing and removing dependency values from the package project. If the “add dependency” icon is pressed, a dialog appears for the packager 20 that allows the input of the type and name of the dependency. The “name” is simply the name of the package to check for on the system. The values provide the option of “type,” which include “requires” and “conflicts with.” If “requires” is selected in the dropdown, the GUI 18 informs the package that the package identified in this dialog is required to be installed on the system. The packager may further input specific package information into this dialog that allows for “any version” to be installed to pass the dependency check, “>=(greater than or equal to dependency)”, “>(greater than the dependency)”, “=(equal to the dependency)”, “<=(less than or equal to the dependency)”, or “<(less than the dependency)”. If the dependency being used is not set to “any version”, the packager is required to input the “Version”, “Version-Release” and/or “S serial_number”.

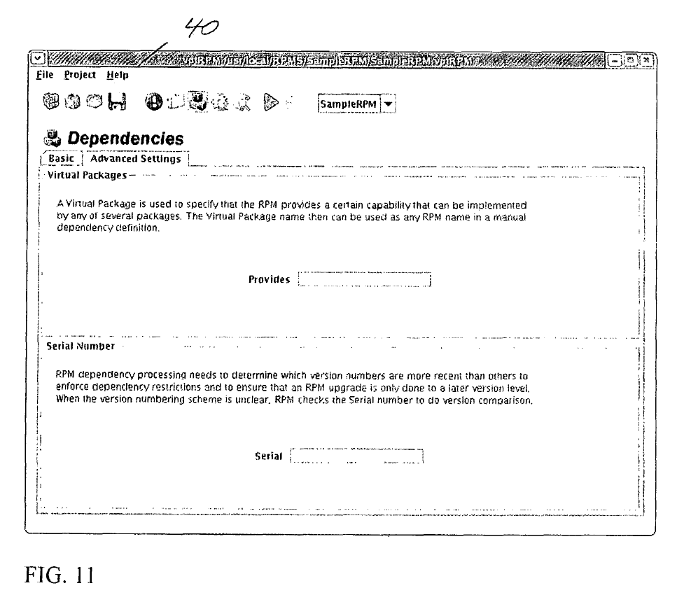

FIG. 11 is a screen shot of the GUI 18 that enables a user to manage package dependencies with an “advanced settings” tab selected. The advanced setting tab enables the packager 20 to create a virtual package and assign a serial number of the software package 16. This allows the packager 20 to identify “virtual Packages” in the “provides” field. A virtual package is used to specify that the RPM provides a certain capability that may be implemented by any of several packages. The virtual package name may be used as any RPM name in a manual dependency definition. RPM dependency processing needs to determine which version numbers are more recent than the others to enforce dependency restrictions and ensure that the RPM upgrade is only done to a later version level. When the version numbering scheme is unclear, RPM checks the serial number to conduct a version comparison. A “serial” field may also be available on the advanced settings tab of the dependency screen to allow for the serial number to be set.

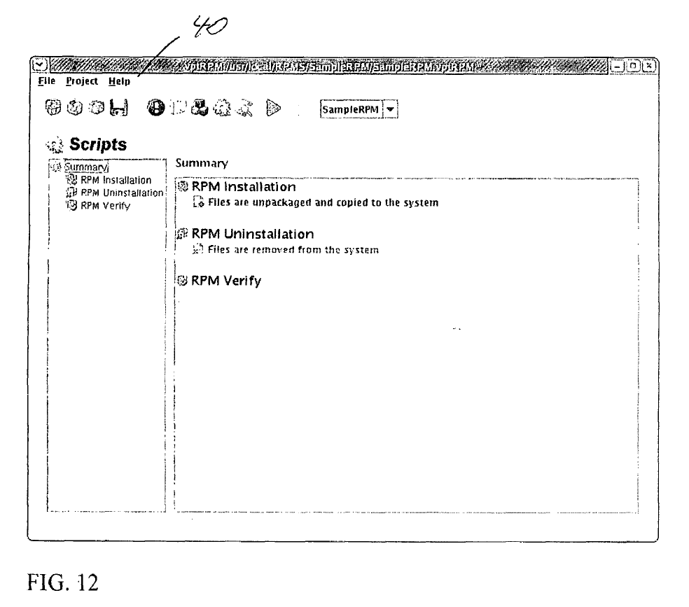

FIG. 12 is a screen shot of the GUI for starting the RPM package building process. As illustrated in FIG. 12, the GUI 18 illustrates a “scripts” screen. The scripts screen preferably provides the packager 20 the ability to create or import pre-existing custom scripts that may be executed within the package 16 at installation time and un-installation time. In the preferred embodiment of the present invention, there are five icons presented to the packager 20 on the scripts screen. These icons are used for adding a script, editing a script, removing a script and changing the order (up or down) of when the scripts are executed. When the “add script” icon (not shown) is pressed, a new dialog appears for the packager. Preferably, this is a text editor that inserts the input into the % pre, % post, % preun, or % postun. % pre is executed at install time before the package files are installed to the server (computing system 12). % post is executed at install time after the package files are installed to the computing system 12. % preun is executed at un-install time before the package files are removed from the system. % postun is executed at un-install time after the package files are removed from the system.

The scripts screen may include a “verify” option which provides scripts that are executed when the package is installed to give the packager 20 the ability to verify certain things conducted within the package 16. The scripts screen may also include an “edit” icon so that if the packager saves the package project and re-opens it, the packager may go back and edit scripts within the package before it is built. Preferably, there are two arrows for moving the scripts created by the packager to a different order. For example, if a script is created and the packager desires to execute the script before the files are installed, the packager may use the “up arrow” icon to move the script above the “files are unpackaged and copied to the system” line in the installation section of this screen. Likewise, the same process may be used for the “Uninstallation” section of this screen. After the packager has written scripts for the package 16, the written scripts may be saved outside the package projects as “package scriptlets.”

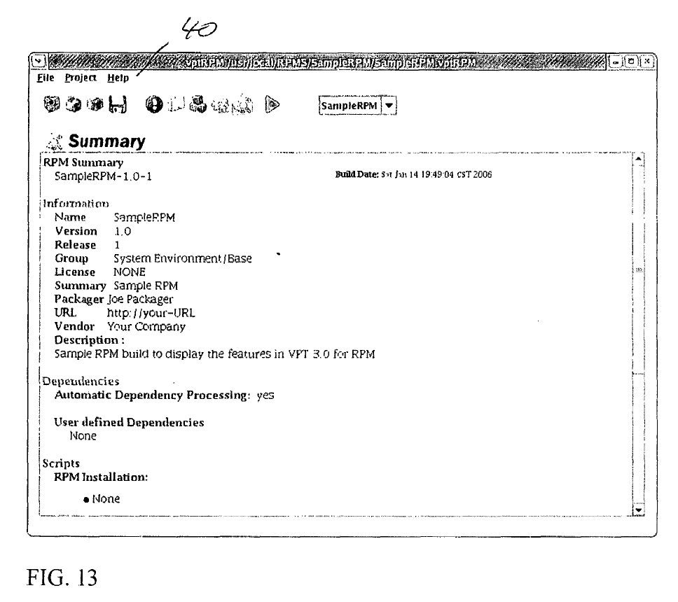

FIG. 13 illustrates the GUI 18 displaying the package 16 information selected. Preferably, the GUI provides a package “Summary” screen which lists all of the information about the package 16 that is being created. If required information is missing, the GUI may identify this information on the screen. Preferably, the GUI identifies missing information for required fields by displaying “missing information” in red type. Below is an exemplary package summary:

### RPM Summary

Build Date Tue Mar 21 20:07:29 CST 2006
Information
Name
Version
Release
Group
License
Summary
Description:

### Dependencies

Automatic Dependency Processing:
User defined Dependencies

### Scripts

RPM Installation:
None

### RPM Uninstallation:

None

### RPM Verify:

None

### RPM contents

### Directories

Files

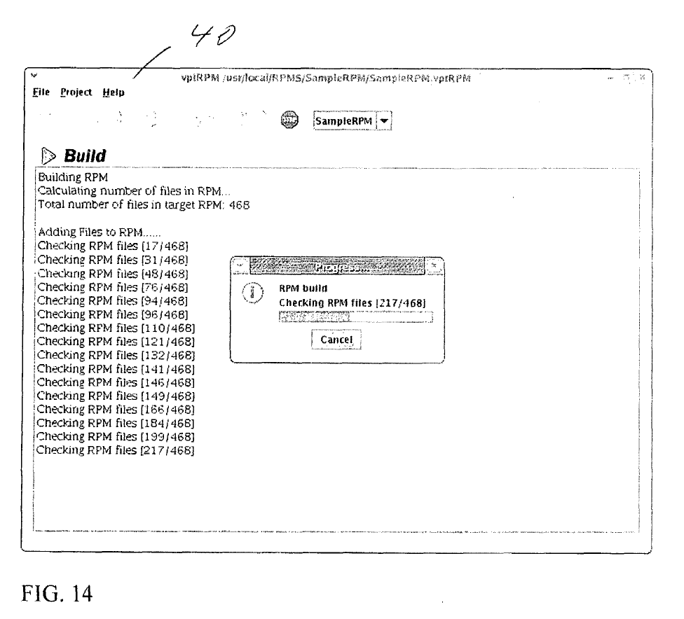

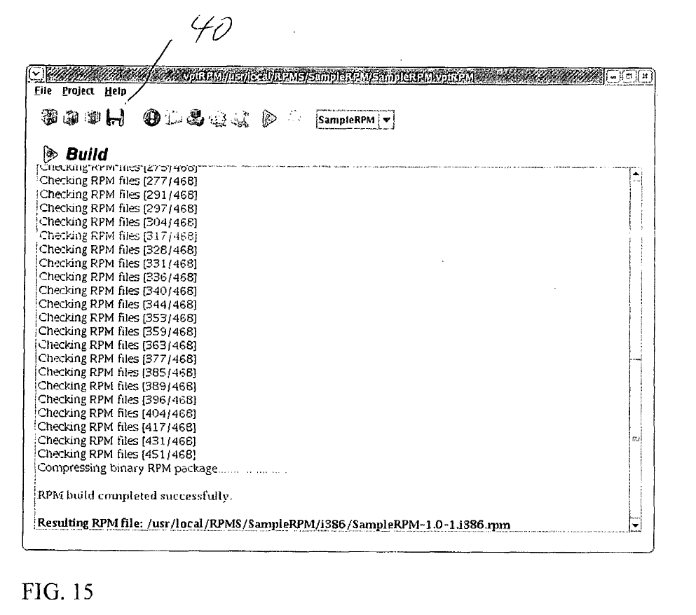

FIG. 14 is a screen shot of the GUI 18 displaying the package building progress and activity of the package 16. As illustrated in FIG. 14, the GUI displays a “build” screen. This screen is displayed when the “build” icon is selected in the icon navigation bar. With all items being typographically correct in the package, the build screen appears by pressing the “build” icon. This screen displays the status of the package being built by listing a count of the files as they are being built into the package. Preferably, there is also a “stop” Icon on the icon navigation bar 50 that may be pressed to stop the building process. Anytime the build icon is pressed and changes have been made to the package, a dialog preferably appears prompting the packager to save the project. If the package exists and the packager 20 selects the Build icon, a new dialog appears that prompts the packager to save the project. If “no” is selected, the package is not be saved. In addition, the screen returns to the screen that was active when the Build icon was pressed. If “yes” is selected, the package 16 is saved and another dialog appears asking if the current package should be overwritten. If the name of the package, version, or release, is different from any other package built within this project, a new package is preferably built with the current settings. FIG. 15 illustrates a screen shot of the GUI displaying the package build completion status.

The GUI 18 may also include a “backwards engineer package” (BEP) feature which allows the packager the ability to edit packages not originally created by the invention. This includes the ability to edit any standard RPM or System V package. This feature is invoked by simply by clicking “open” from the projects screen (see FIG. 4). The GUI 18 extracts the files from the package and enables the packager 20 to view, modify, and save the package.

The GUI also may include the ability to dynamically setup configuration files based on information provided through application specific variables (ASV). The ASV feature of the GUI allows the packager 20 the ability to create configuration files with variable names instead of the actual configuration setting. In addition, the settings may also be built, edited and placed on the computer system 12 for which the package 16 is to be installed. This feature is helpful when the applications have specific application settings for different environments. Using the ASV feature eliminates having to build multiple packages for the same application that requires specific configuration based on the environment. For example, if the packager 20 builds a package and it has a configuration file that requires the hostname of the machine, the packager 20 may simply build the package using the ASV feature of the GUI and insert a variable $HOSTNAME into the package. The packager may then setup the ASV file with the following commands identifying the hostname of the computing system 12 where the package 16 is installed:

var/anchor/server1.pkgname.asv:

### HOSTNAME=server1

At this point, the packager may install the package on any server (computing system) without having separate packages. The ASV enabled package identifies the variables and replaces them into the configuration file identified in the package as ASV enabled configuration files.

The GUI 18 may also include an automatic transfer feature of the package created by the packager 20 by simply clicking transfer and selecting a stored target system profile or by inputting the target system information. The transfer feature may utilize either SSH, SFTP, or FTP to transfer the package to another site with the above protocols enabled. The GUI 18 provides the ability to create and store transfer profiles including target system name, transfer protocol selection, IP address, username, and password.

The GUI 18 may also provide the ability to build source packages the same way a standard package is built. A source RPM contains source files and other files such as makefiles needed to compile the source package on a target system. The packager 20 may also create and store scriptlets to execute the code compilation before the package is installed, if desired.

The RPM spec file is the main file used to build an RPM package containing the package information collected and properly formatted by the GUI 18. The GUI 18 preferably includes a spec file icon that displays an interface that allows the packager 20 to view, edit, and save the current spec file for the project that is opened. This enables an advanced packager to override the GUI 18 and modify the spec file contents to insert an RPM feature not accessible through the GUI or to modify RPM commands in the spec file generated by the GUI 18.

The GUI 18 may also include an RPM update feature that enables inclusion of a series of scriptlets the packager 20 may wish to import into the package scripts when building an updated package 16. When a packager updates a package with rpm -U, the original package uninstall scripts are run. This may be harmful to the functionality of the application. The present invention may overcome this shortcoming by adding simple scriptlets that can be added to identify what type (-i, -U, -e) of installation is being conducted. In addition, the RPM may be directed to run the scriptlets based on this type.

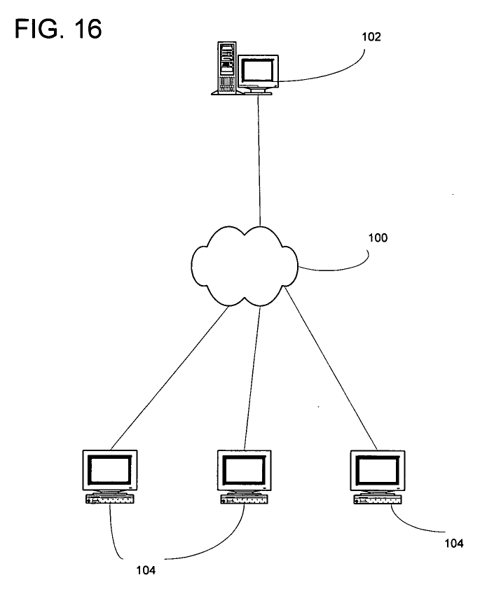

The present invention allows access to packages by the packager locally. FIG. 16 is a simplified block diagram of a network 100 for use by packagers for building a package remotely. In the preferred embodiment of the present invention, a packaging server 102 is a network-based building component where one or more distributed servers 104 are used to build the package. Packagers 20 access the packaging server from client applications on their local Unix or Linux server or their PC desktops. A packaging client may then be provided that connect via the network 100, thereby allowing packaging on the packaging server from any authorized remote desktop client. A packaging server administrator may setup user and group accounts and assign projects to those users and/or groups. Authentication is preferably required from the client to login to the packaging server.

The present invention may also utilize an admin console providing a GUI interface to setup user accounts on the packaging server 102 and separate packaging projects based on user and/or groups of users. This feature offers administrators the ability to separate projects, groups, and individual users. Once the user has logged into the packaging server 102 through the packaging client and been authenticated. each server 104 displays only those projects belonging to that user.

The present invention may also provide a packaging client that runs on Windows, Linux, Solaris, AIX and HP-UX and other UNIX platforms. The packaging client feature of the GUI 18 enables a packager 20 to select a packaging server profile and connect to the selected packaging server 102 over an IP network 100. The packaging client feature of the GUI enables the packager to create, modify, and save packaging server profiles containing packaging server name, IP address, username and password.

The present invention may also include a packaging web client that is a java interface that may be run via most web browsers and provides the same functionality as the packaging client. The web client feature of the GUI 18 enables a packager 20 to select a packaging server profile and connect to the selected packaging server 102 over the IP network 100. The web feature of the GUI enables the packager to create, modify, and save packaging server profiles containing packaging server name, IP address, username and password.

The present invention provides a wide variety of features not available in software packaging of Linux or Unix operating platforms. The present invention provides the ability to manage multiple projects. The GUI 18 allows packagers 20 to create new projects, open, save, and close existing projects containing one or more software packages. The packaging system 10, through the GUI 18, generates and manages required and optional RPM parameters and specific package information such as package name, version, description, license, URL, packager name and phone number. This information is stored in the package and can be retrieved on any system where the RPM package is installed. The packaging system 10 enables users to drag and drop selected files to be packaged from the source environment to the target packaging environment graphically creating a packaging tree. It enables packagers to manage the attributes of files within the package. The GUI 18 may also allow the capability to create, delete and modify pre-installation, post-installation, and install time scripts to control and customize target system environments. The dependency feature of the GUI preferably allows the packager to setup dependency packages that are required to be installed for the current package to install correctly. The dependency feature provides the packager the ability to auto discover dependencies installed on a system. The software packaging system also enables users to control package security by digitally signing each package to prevent unauthorized users from accessing the software package. The software packaging system also enables users to control package security by digitally signing each package. Digitally signing a package with an encrypted key allows the user to determine the validity of a package installed on a system with a matching key pair installed on that system.

The present invention also provides version tracking and management. Package projects may be easily edited through the GUI 18. The GUI also preferably includes the following features: the adding and management of package dependencies, create or change scripts within a package and manage file attributes easily by a packager. Hundreds of new open-source packages are available daily by various websites providing RPM downloads. With the present invention, management of these packages is made far easier. The present invention allows the packager to set package requirements expressed in terms of other package names or files. The present invention also allows a package to be rebuilt form source code.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A software packaging system, the software packaging system comprising:
a computing system operating a Unix or Linux operating platform;
a software package executable by the operating platform; and
a graphical user interface (GUI) operable within the computing system and operating platform;
the GUI having a user interface element actuable by a user, the user interface element providing management of packaging of the software package in the computing system.

2. The software packaging system of claim 1 wherein the computing system operates a native package manager operable upon the operating platform.

3. The software packaging system of claim 2 wherein the native package manager is Red Hat Package Manager (RPM).

4. The software packaging system of claim 3 wherein the user interface element includes a means for managing a plurality of software package projects, each project associated with a software package.

5. The software packaging system of claim 4 wherein the means for managing a plurality of software package projects includes a capability to allow opening, closing and saving of each project by the user.

6. The software packaging system of claim 4 wherein the user interface element provides project information upon request by the user through the GUI.

7. The software packaging system of claim 4 wherein the user interface element of the GUI includes a means for navigating subordinate package creation interfaces.

8. The software packaging system of claim 3 wherein the user interface element of the GUI includes a means for listing system files and attributes available for inclusion into the software package.

9. The software packaging system of claim 8 wherein the GUI includes a means for dragging and dropping files within the GUI for software packaging.

10. The software packaging system of claim 3 wherein the user interface element includes a means for entering specific required or optional package information to the software package.

11. The software packaging system of claim 3 wherein the user interface element provides a means for modifying file or directory attributes of the software package.

12. The software packaging system of claim 3 wherein the user interface element provides a means for modifying the native package manager flags.

13. The software packaging system of claim 3 wherein the user interface element includes a means for managing package dependencies.

14. The software packaging system of claim 13 wherein the means for managing package dependencies includes a means for checking automatic dependency of the software package.

15. The software packaging system of claim 3 wherein the user interface element includes means for creating and managing scripts executable at installation, uninstallation or verification time of the software package within the computing system.

16. The software packaging system of claim 3 wherein the user interface element includes a means for identifying a type of package architecture utilized by the software package.

17. The software packaging system of claim 3 wherein the user interface includes a means for digitally signing the software package by the user.

18. The software packaging system of claim 3 wherein the user interface element includes an application specific variables (ASV) means allowing the user to dynamically setup configuration files.

19. The software packaging system of claim 3 wherein the software packaging system is operable upon a centralized packaging server.

20. The software packaging system of claim 3 wherein the user interface element includes a means for saving and reusing scripts for use within the software package.

21. The software packaging system of claim 3 wherein the system includes a means for automatically transferring the software package to a target system.

22. The software packaging system of claim 3 wherein the software packaging system includes a means for building a source RPM.

23. The software packaging system of claim 3 wherein the user interface element includes a means for editing a spec file utilized in building the software package.

24. The software packaging system of claim 3 wherein the software packaging system may be operable over an IP network.

25. A software packaging system, the software packaging system comprising:
a computing system operating a Unix or Linux operating platform;
a software package executable by the operating platform;
the operating platform operating a native package manager for managing installation of the software package; and
a graphical user interface (GUI) operable within the computing system and operating platform;
the GUI having a user interface element actuable by a user, the user interface element providing management of packaging of the software package in the computing system including:
means for managing a plurality of software package projects, each project associated with a software package;
means for listing system files and attributes available for inclusion into the software package;
means for entering specific required or optional package information to the software package;
means for modifying file or directory attributes of the software package;
means for modifying the native package manager flags;
means for managing package dependencies; and
means for creating and managing script executable at installation, uninstallation or verification time of the software package within the computing system.

26. A method of packaging a software package within a computing system operating a Unix or Linux operating platform, the method comprising the steps of:
providing a graphical user interface (GUI) operable within the computing system and operating platform; and
providing executable instructions by a user to the GUI, the GUI having a user interface element providing management of packaging of the software package in the computing system.

27. The method of packaging a software package of claim 26 herein the computing system operates a native package manager operable upon the operating platform.

28. The method of packaging a software package of claim 27 wherein the user interface element includes:
means for managing a plurality of software package projects, each project associated with a software package;
means for listing system files and attributes available for inclusion into the software package;
means for entering specific required or optional package information to the software package;
means for modifying file or directory attributes of the software package;
means for modifying the native package manager flags;
means for managing package dependencies; and
means for creating and managing script executable at installation, uninstallation or verification time of the software package within the computing system.
